(19) United States
(12) Patent Application Publication
(10) Pub. No.: US 2009/0195549 A1
(43) Pub. Date: Aug. 6, 2009

(54) Color gradient generating method and device

(75) Inventor: Ki-Hyun Park, Seoul (KR)

Correspondence Address: BIRCH STEWART KOLASCH & BIRCH, PO BOX 747, FALLS CHURCH, VA, 22040-0747, US

(73) Assignee: MTEKVISION CO. LTD., Seoul (KR)

(21) Appl. No.: 12/320,632

(22) Filed: Jan. 30, 2009

(30) Foreign Application Priority Data
Jan. 31, 2008 (KR) 10-2008-0010023

(51) Int. Cl. G09G 5/02

(52) U.S. Cl. 345/589

(57) ABSTRACT

Color gradient generating method and device are provided. The color gradient generating method includes the steps of: setting at least two colors in a color table including a plurality of colors as control points; storing interpolated colors between the control points; calculating a distance of a position, a color of which should be determined, in coordinates; and determining one interpolated color corresponding to the calculated distance as a color of the position. Accordingly, it is possible to reduce the operating time of a graphic processor and to use the calculation result in image coordinates again, thereby reducing a load of the graphic processor.

### CROSS-REFERENCE TO RELATED APPLICATIONS

This application claims the benefit of Korean Patent Application No. 10-2008-0010023 filed with the Korean Intellectual Property Office on Jan. 31, 2008, the disclosures of which are incorporated herein by reference in their entirety.

### BACKGROUND

1. Field of the Invention

The present invention relates to color gradient generating method and device, and more particularly, to color gradient generating method and device for expressing a smooth color variation in a two-dimensional vector graph.

2. Related Art

Methods of expressing colors in a two-dimensional vector graph employ a solid expressing a single color, a gradient expressing a smooth color variation, and a bit map using an image file.

When a user selects a specific area, the selected area can be filled with one or plural colors.

When the selected specific area is filled with plural colors, the plural colors can be automatically mixed. The smooth mixture of the colors is called color gradient.

The color gradient is roughly classified into linear gradients and radial gradients and can be usually generated using line segments.

FIG. 1 is a diagram illustrating a radial gradient 110 and a linear gradient 120 generated using a line segment 100.

In FIG. 1, a line segment 100 should be first specified to fill an area, for example, a pixel, using the linear gradient 120. Colors correspond to points located along the line segment 100.

For example, as shown in FIG. 1, one end point in the line segment can be set to blue, the other end point can be set to red, and a middle point in the line segment 100 can be set to yellow.

With the setting of the line segment 100, a color of a different point in the line segment 100 can be determined by interpolating the specific colors. The interpolation of colors can be carried out in various interpolation methods such as linear interpolation or cubic interpolation.

A color of a different point in the area to be filled is determined to be the same as the color of the closest point in the line segment 100.

The linear gradient 120 is the most basic gradient of all gradients.

The radial gradient 110 can be used to exhibit a slightly more complex effect than the linear gradient 120. A start point and an end point should be selected in the line segment 100 to generate the radial gradient 110.

In the radial gradient 110, similarly to the linear gradient 120, colors correspond to points in the line segment 100 and a color of a middle point in the line segment 100 is determined by interpolating specific colors.

The radial gradient 110 is different from the linear gradient 120, in that a color of a different point in the area to be filled is determined on the basis of a distance from the start point in the line segment 100 in view of the characteristic of circle.

Accordingly, the final radial gradient 110 includes concentric rings of colors smoothly and continuously varying.

Colors are smoothly mixed from the start point in the line segment 100, similarly to the linear gradient 120. The points in different beams starting from the start point are colored in the same method depending on the distance from the start point.

The procedure of generating the known color gradient will be described in detail with reference to FIG. 2.

FIG. 2 is a diagram schematically illustrating a known procedure of generating a gradient.

As shown in FIG. 2, when a position of which a color should be determined is selected (S200), a distance of the position in image coordinates is calculated (S202).

The position of which the color should be determined may be a position in a pixel or a position in an area determined in advance by a user.

Two colors to be mixed are checked in the line segment on the basis of the calculated distance (S204) and the distances from the colors to be mixed are calculated (S206).

The color of the position in a pixel is finally determined on the basis of the color calculation result (S208).

The interpolation for determining a color can be performed using the following expression.

$$\frac{a \cdot {L}_{color} + b \cdot {R}_{color}}{a + b}$$

The known color gradient generating method of performing the above-mentioned procedure has a problem that the operating time of a graphic processor increases because all gradient colors should be calculated per pixel.

When a color gradient is used in one object, the calculated distances in image coordinates may be equal to each other, that is, the calculation results in step 202 may be equal to each other.

However, even when the distances are equal to each other, the distance calculation in the image coordinates should be performed again.

Therefore, there is a problem that the operating time of the graphic processor and the load of the graphic processor due to the repeated calculation increase.

### SUMMARY

An advantage of some aspects of the invention is that it provides color gradient generating method and device that can reduce the operating time of a graphic processor.

Another advantage of some aspects of the invention is that it provides color gradient generating method and device that can use a distance calculation performed in image coordinates again when distances are equal to each other.

Another advantage of some aspects of the invention is that it provides color gradient generating method and device that can reduce a load of a graphic processor.

Other advantages of the invention will be easily understood from the following description.

According to an aspect of the invention, there is provided a color gradient generating method.

The color gradient generating method includes the steps of: (a) setting at least two colors in a color table including a plurality of colors as control points; (b) storing interpolated colors between the control points; (c) calculating a distance of a position, a color of which should be determined, in coordinates; and (d) determining one interpolated color corresponding to the calculated distance as a color of the position.

The step of (b) may include storing the interpolated colors to correspond to control points located between the control points. The step of (d) may include the sub-steps: searching for the control point corresponding to the calculated distance; and

reading the color corresponding to the searched control point.

The steps of (c) and (d) may be repeatedly performed on all positions of which the colors should be determined. The color gradient generating method may further include a step of temporarily storing the calculated distance and the determined color. Here, the step of (d) may include reading the temporarily-stored color when the calculated distance in the step of (c) is equal to the temporarily-stored distance.

According to another aspect of the invention, there is provided a color gradient generating device.

The color gradient generating device calculates a distance of a position, a color of which should be determined, in coordinates and determines the color of the position in accordance with the calculated distance. Here, the determined color is one of colors obtained by setting at least two colors as control points in a color table including a plurality of colors and interpolating the colors between the control points.

The interpolated colors may be stored to correspond to control points located between the control points and the color of the position may be determined on the basis of the calculated distance by searching for the control point corresponding to the calculated distance and reading the color corresponding to the searched control point.

The distance calculation in the coordinates and the color determination of the position may be repeatedly performed. The calculated distance and the determined color may be temporarily stored and the temporarily-stored color may be read when a distance calculated in the coordinates is equal to the temporarily-stored distance.

According to another aspect of the invention, there is provided a graphic processor.

The graphic processor includes the above-mentioned color gradient generating device.

According to another aspect of the invention, there is provided a recording medium having recorded thereon a program for executing a color gradient generating method.

Here, the recording medium has recorded thereon a computer-readable program allowing a digital processor to execute the color gradient generating method. The color gradient generating method includes: (a) setting at least two colors in a color table including a plurality of colors as control points; (b) storing interpolated colors between the control points; (c) calculating a distance of a position, a color of which should be determined, in coordinates; and (d) determining one interpolated color corresponding to the calculated distance as a color of the position.

The step of (b) may include storing the interpolated colors to correspond to control points located between the control points. The step of (d) may include the sub-steps: searching for the control point corresponding to the calculated distance; and reading the color corresponding to the searched control point.

The steps of (c) and (d) may be repeatedly performed on all positions of which the colors should be determined. The color gradient generating method may further include a step of temporarily storing the calculated distance and the determined color. Here, the step of (d) may include reading the temporarily-stored color when the calculated distance in the step of (c) is equal to the temporarily-stored distance.

As described above, according to the above-mentioned color gradient generating method and device, it is possible to reduce the operating time of a graphic processor.

It is also possible to reuse the calculation result in the image coordinates.

Accordingly, it is possible to reduce the load of the graphic processor.

### BRIEF DESCRIPTION OF THE DRAWINGS

FIG. 1 is a diagram illustrating a radial gradient and a linear gradient generated using a line segment.

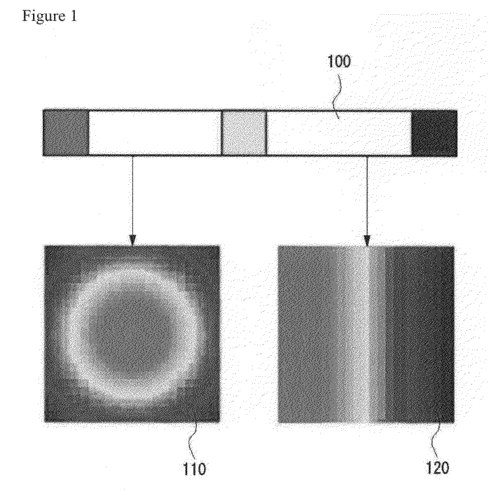

FIG. 2 is a diagram schematically illustrating a known procedure of generating a gradient.

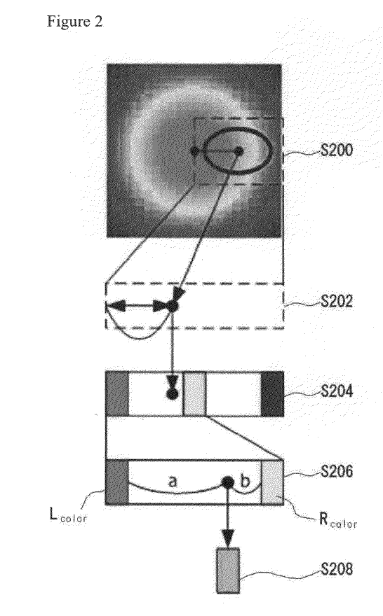

FIG. 3 is a diagram schematically illustrating a procedure of generating a color table for generating a gradient according to an embodiment of the invention.

FIG. 4 is a diagram schematically illustrating a gradient generating procedure according to an embodiment of the invention.

FIG. 5 is a diagram illustrating a configuration of a digital processor including a two-dimensional graphic processor which has a gradient generating device according to an embodiment of the invention.

### DESCRIPTION OF EXEMPLARY EMBODIMENTS

The above-mentioned goals, features, and advantages of the invention will be apparent from the following detailed description with reference to the accompanying drawings. The invention can be variously modified in various embodiments and specific embodiments will be described and shown in the drawings. The invention is not limited to the embodiments, but it should be understood that the invention includes all the modifications, equivalents, and replacements belonging to the spirit and the technical scope of the invention.

Like reference numerals reference like elements in the drawings. When it is determined that detailed description of known techniques associated with the invention makes the gist of the invention obscure, the detailed description will be omitted.

Terms, “first”, “second”, and the like, can be used to describe various elements, but the elements are not limited to the terms. The terms are used only to distinguish one element from another element.

The terms used in the following description are used to merely describe specific embodiment, but are not intended to limit the invention. An expression of the singular number includes an expression of the plural number, so long as it is clearly read differently. The terms such as “include”, “have”, and the like are intended to indicate that features, numbers, steps, operations, elements, components, or combinations thereof used in the following description exist and that the possibility of existence or addition of one or more different features, numbers, steps, operations, elements, components, or combinations thereof is not excluded.

Hereinafter, exemplary embodiments of the invention will be described in detail with reference to the accompanying drawings.

In an embodiment of the invention, a color table is used to generate a color gradient, so as to reduce the amount of calculation of a graphic processor.

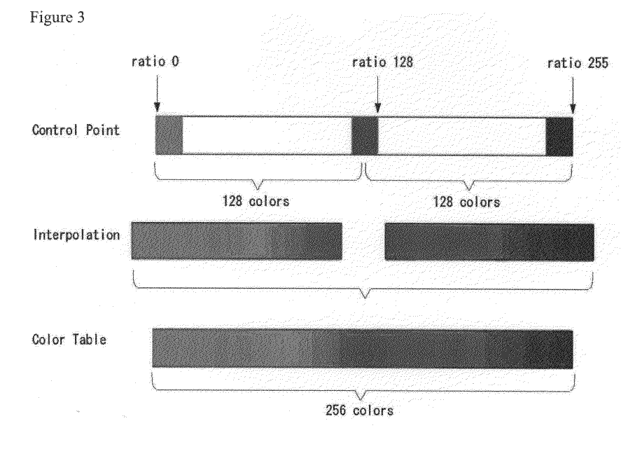

A procedure of generating a color table used in the embodiment of the invention will be described with reference to FIG. 3.

FIG. 3 is a diagram schematically illustrating the procedure of generating a color table for generating a color gradient according to the embodiment of the invention.

The color table that can be used to generate a color gradient includes plural colors, which can be generated using two or more colors as control points.

FIG. 3 shows an example where the color table includes 256 values. In order to generate the color table in FIG. 3, control points have values from ratio 0 to ratio 255 can be set.

Interpolated colors are filled between the control points in the color table to generate the color data and the generated color data is stored in a storage unit such as a memory.

In FIG. 3, it is assumed that ratio 0, ratio 128, and ratio 255 are set as the control points and ratio 0, ratio 128, and ratio 255 correspond to red, green, and violet, respectively.

Then, interpolated color data between red and green is generated between ratio 0 and ratio 128 and is stored in the memory. Interpolated color data between green and violet is generated between ratio 128 and ratio 255 and is stored in the memory.

For example, the colors are determined in such a manner that red is set to ratio 0, a color in which a slight amount of green is mixed with red is set to ratio 1, and a color in which a slight more amount of green is mixed is set to ratio 2. Accordingly, when a value of a color is ratio 128, the corresponding color is green.

The color data generated and stored in the memory is used to generate a gradient.

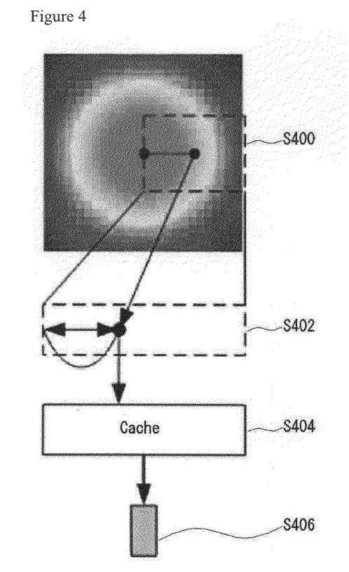

A procedure of generating a gradient using the color data stored in the memory will be described now with reference to FIG. 4.

FIG. 4 is a diagram schematically illustrating a gradient generating procedure according to an embodiment of the invention.

As shown in FIG. 4, when a position of which the color should be determined is selected (S400), a distance of the selected position in image coordinates is calculated (S402).

As described above, the position of which the color should be determined may be a position in a pixel or a position in an area determined in advance by a user.

The calculated distance is used as an address in a cache memory included in a graphic processor (S404) and a color having a value corresponding to the calculated distance is extracted from the memory (S406).

For example, when the color value corresponding to the calculated distance is a value corresponding to ratio 128 between control point 0 and control point 128 in FIG. 3, the value corresponds to green and thus green is finally determined as the color of the position.

On the other hand, in the past, two colors to be mixed were checked in the line segment on the basis of the calculated distance, distances from the colors to be mixed were calculated, and then the color of the position was determined in accordance with the calculation result.

However, in the invention, since the color data corresponding to distances calculated in advance is stored in the memory and the corresponding color data is read from the memory on the basis of the calculated distance, the calculation process of determining a color can be omitted.

In the invention, since a color corresponding to the calculated distance is extracted from the memory using the calculated distance as an address in the cache memory of the graphic processor, the color data stored in the cache memory can be utilized for the same position, that is, the same distance.

Therefore, the graphic processor need not perform again the procedure of checking two colors to be mixed in the line segment on the basis of the calculated distance and calculating the distances from the colors to be mixed.

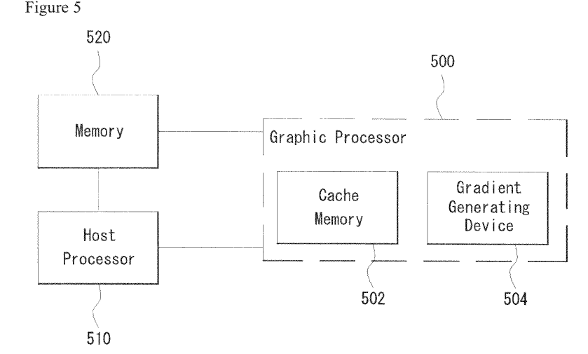

FIG. 5 is a diagram illustrating a configuration of a digital processor including a graphic processor which has a gradient generating device according to an embodiment of the invention.

The digital processor including the graphic processor which has the gradient generating device according to the embodiment of the invention includes a graphic processor 500, a host processor 510, and a memory 520.

The graphic processor 500 includes the gradient generating device 504 according to the embodiment of the invention and the gradient generating device 504 is connected to the cache memory 502 of the graphic processor 500.

The graphic processor 500 is a logical circuit processing image information of the digital processor and displaying the processed information on a screen. The host processor 510 is a logical circuit processing commands for basic operations of the digital processor.

The gradient generating device 504 of the graphic processor 500 generates a color gradient in an area using color data stored in the memory 520 and the cache memory 502 of the graphic processor 500, as described above.

The cache memory 502 is a storage unit temporarily storing data to be processed by the graphic processor 500 and may temporarily store the color, which is extracted from the memory 520, corresponding to the calculated distance of a position of which the color should be determined.

The calculated distance of the position of which the color should be determined can be used as an address in the cache memory 502.

The memory 520 is a storage unit storing data to be processed by the digital processor and particularly stores color data used to generate a gradient in the embodiment of the invention.

In the digital processor having the above-mentioned configuration, color data set in advance to generate a color gradient of an area is stored in the memory. The color used to generate the color gradient of a position in the area is determined by reading the corresponding color data from the memory.

The calculated is used as an address in the cache memory of the graphic processor and the color data stored in the cache memory can be used for the same position, that is, the same distance value, thereby reducing the processing time and the processing load of the graphic processor 500.

Although the invention has been described with reference to the exemplary embodiments, it will be understood by those skilled in the art that the invention can be modified and changed in various forms without departing from the spirit and scope of the invention described in the appended claims and the modifications and changes belong to the appended claims.

What is claimed is:

1. A color gradient generating method comprising the steps of:
(a) setting at least two colors in a color table including a plurality of colors as control points;
(b) storing interpolated colors between the control points;
(c) calculating a distance of a position, a color of which should be determined, in coordinates; and
(d) determining one interpolated color corresponding to the calculated distance as a color of the position.

2. The method according to claim 1, wherein the step of (b) includes storing the interpolated colors to correspond to control points located between the control points.

3. The method according to claim 2, wherein the step of (d) includes the sub-steps:
searching for the control point corresponding to the calculated distance; and
reading the color corresponding to the searched control point.

4. The method according to claim 1, wherein the steps of (c) and (d) are repeatedly performed on all positions of which the colors should be determined.

5. The method according to claim 4, further comprising a step of temporarily storing the calculated distance and the determined color,
wherein the step of (d) includes reading the temporarily-stored color when the calculated distance in the step of (c) is equal to the temporarily-stored distance.

6. A color gradient generating device calculating a distance of a position, a color of which should be determined, in coordinates and determining the color of the position in accordance with the calculated distance,
wherein the determined color is one of colors obtained by setting at least two colors as control points in a color table including a plurality of colors and interpolating the colors between the control points.

7. The device according to claim 6, wherein the interpolated colors are stored to correspond to control points located between the control points, and
wherein the color of the position is determined on the basis of the calculated distance by searching for the control point corresponding to the calculated distance and reading the color corresponding to the searched control point.

8. The device according to claim 6, wherein the distance calculation in the coordinates and the color determination of the position are repeatedly performed.

9. The device according to claim 8, wherein the calculated distance and the determined color are temporarily stored and the temporarily-stored color is read when a distance calculated in the coordinates is equal to the temporarily-stored distance.

10. A graphic processor comprising the color gradient generating device calculating a distance of a position, a color of which should be determined, in coordinates and determining the color of the position in accordance with the calculated distance,
wherein the determined color is one of colors obtained by setting at least two colors as control points in a color table including a plurality of colors and interpolating the colors between the control points.

11. A recording medium having recorded thereon a computer-readable program allowing a digital processor to execute a color gradient generating method, the color gradient generating method comprising the steps of:
(a) setting at least two colors in a color table including a plurality of colors as control points;
(b) storing interpolated colors between the control points;
(c) calculating a distance of a position, a color of which should be determined, in coordinates; and
(d) determining one interpolated color corresponding to the calculated distance as a color of the position.
